(19) United States
(12) Patent Application Publication
(10) Pub. No.: US 2016/0164815 A1
(43) Pub. Date: Jun. 9, 2016

(54) TERMINAL DEVICE AND DATA PROCESSING METHOD THEREOF

(71) Applicant: Samsung Electronics Co., Ltd., Suwon-si (KR)

(72) Inventors: Sang-wook CHO, Suwon-si (KR); Yu-na KIM, Suwon-si (KR)

(21) Appl. No.: 14/953,204

(22) Filed: Nov. 27, 2015

(30) Foreign Application Priority Data
Dec. 8, 2014 (KR) 10-2014-0175066
Aug. 7, 2015 (KR) 10-2015-0111741

(51) Int. Cl. H04L 12/58; G06F 3/0484; G06F 3/0346; G06F 3/0481

(52) U.S. Cl. CPC H04L 51/16; H04L 51/04; G06F 3/0481; G06F 3/04842; G06F 3/0346

(57) ABSTRACT

A terminal device is provided. The terminal device includes a communication interface configured to perform communication with an external device, as chatting begins, a display configured to display chatting messages sent and received through the communication interface, a storage, and a processor configured to classify the chatting messages into a plurality of dialogue sessions, store keywords for defining the respective classified dialogue sessions on the storage, and provide the dialogue session matching at least one keyword through the display when an event associated with at least one keyword among the plurality of keywords stored on the storage occurs.

### CROSS-REFERENCE TO RELATED APPLICATION(S)

This application claims the benefit under 35 U.S.C. §119(a) of a Korean patent application filed on Dec. 8, 2014 in the Korean Intellectual Property Office and assigned Serial No. 10-2014-0175066, and of a Korean patent application filed on Aug. 7, 2015 in the Korean Intellectual Property Office and assigned Serial number 10-2015-0111741, the entire disclosure of each of which is hereby incorporated by reference.

### TECHNICAL FIELD

The present disclosure relates to a terminal device and a data processing method thereof. More particularly, the present disclosure relates to a terminal device configured to provide analysis and search based on a unit of dialogue by classifying chatting messages sent and received in the past into the unit of dialogue, and a data processing method thereof.

### BACKGROUND

Development of electronic technology has enabled a variety of services to be provided through a personal terminal device. A user can easily have a dialogue with another user of another terminal device through the terminal device such as a smartphone. For example, a user may send and receive chatting messages to and from another user by using a terminal device.

The chatting messages of a user which have been sent and received to and from another user may be stored in the terminal device or in a server providing the chatting service, and the user may read the past chatting messages.

However, a user has to read the dialogues one by one starting from the current chatting messages to the past stored messages in order to read a specific part of the dialogue made in the past. During this process, a user may have a difficulty to correctly find the part of the dialogue which he needs to read, and it sometimes takes a considerable amount of time to do so.

Recent terminal devices are providing a message searching function in order to address the above problem. However, the message searching function simply searches and finds the chatting messages including the text matching the text inputted by a user.

A user searching through the past chatting may want to read how the dialogue went, or with whom or about which topic the dialogue was made, but is not able to do so easily with the message search function of the existing terminal devices unless the user checks the past chatting messages one by one.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a terminal device which can provide an analysis and search based on a unit of dialogue by classifying chatting messages sent and received in the past into the unit of dialogue, and a data processing method thereof.

In accordance with an aspect of the present disclosure, a terminal device is provided. The terminal device includes a communication interface configured to perform communication with an external device, as chatting begins, a display configured to display chatting messages sent and received through the communication interface, a storage, and a processor configured to classify the chatting messages into a plurality of dialogue sessions, and store keywords for defining the respective classified dialogue sessions on the storage.

The processor may provide the dialogue session matching at least one keyword through the display when an event associated with at least one keyword among the plurality of keywords stored on the storage occurs.

The processor may check a transmission time or a reception time of the respective chatting messages and classify the chatting messages which are sent and received for a duration that exceeds a certain time interval into different dialogue sessions to each other.

The processor may classify the dialogue sessions into different dialogue sessions based on a time point of sending or receiving the chatting message including a specific word.

The processor may integrate the plurality of dialogue sessions into one dialogue session when the plurality of dialogue sessions are stored on the storage and the keywords regarding the plurality of dialogue sessions are associated with each other.

In response to inputting of a user manipulation to select at least part of the plurality of chatting messages displayed on the display, the processor may determine the chatting messages within a range corresponding to the inputted user manipulation to be one dialogue session.

The processor may provide a graphic effect to inform of an end of the dialogue session through the display when one dialogue session is finished during chatting, and determine the chatting messages within a range corresponding to the graphic effect to be one dialogue session in response to inputting of a user manipulation to agree with the end of the dialogue session.

The processor may control the display to display a user interface (UI) screen for editing previously defined keywords regarding a specific dialogue session in response to inputting of a user manipulation for editing the keywords.

When an event to input a keyword for searching the dialogue session occurs, the processor may display a list of the dialogue sessions corresponding to the inputted keyword on the display.

The processor may display a chatting area and an associated dialogue session area respectively on a screen of the display, display the chatting messages sent and received through the communication interface on the chatting area, and when an event occurs, in which one keyword among the keywords stored in the storage is displayed on the chatting area, display the dialogue session matching the displayed keyword on the associated dialogue session area.

The processor may display a chatting area and an associated dialogue session area respectively on a screen of the display, display the chatting messages sent and received through the communication interface on the chatting area, and when an event occurs, in which a keyword of the dialogue session inclusive of the chatting messages displayed on the chatting area matches the previous keyword stored on the storage, display the dialogue session matching the previous keyword on the associated dialogue session area.

In response to inputting of a user manipulation to select the dialogue session, the processor may display a new chatting screen inclusive of the chatting messages within the selected dialogue session on the display.

The processor may control the display to display background images associated with the keyword for defining the specific dialogue session on the chatting screen, while the chatting messages within a specific dialogue session are displayed on the chatting screen.

The processor may determine keywords of each dialogue session based on at least one of a dialogue participant, a dialogue subject, a dialogue intention and a dialogue time regarding each dialogue session.

The terminal device may additionally include a sensor configured to sense at least one state regarding a location of the terminal device, a movement of the terminal device, an ambient temperature of the terminal device and an ambient humidity of the terminal device. The processor may determine the keyword for defining the dialogue session which includes the inputted chatting message based on information sensed through the sensor at the moment when the chatting message is inputted.

The processor may receive keywords stored in another terminal device through the communication interface, and determine a popular keyword based on the received keyword and the keywords stored on the storage.

The processor may display an automatically-suggested word on the display while the text is inputted, and the displayed automatically-suggested word may be selected from the popular keywords.

In accordance with another aspect of the present disclosure, a data processing method of a terminal device is provided. The data processing method includes classifying previously stored chatting messages into a plurality of dialogue sessions, storing keywords for defining the respective classified dialogue sessions on a storage of the terminal device, and providing a dialogue session matching at least one keyword through a display of the terminal device when an event associated with at least one keyword among the plurality of keywords stored on the storage occurs.

The classifying may include checking a time point when the respective chatting messages are sent or received, and classifying the chatting messages sent and received for a duration exceeding a certain time interval into different dialogue sessions to each other.

The classifying may include classifying the chatting messages including a specific word into the different dialogue sessions to each other based on a transmission time or a reception time.

In accordance with another aspect of the present disclosure, a non-transient computer readable recording medium including a program to perform a data processing method is provided. The data processing method includes classifying previously stored chatting messages into a plurality of dialogue sessions, storing keywords for defining the respective classified dialogue sessions on a storage of the terminal device, and providing a dialogue session matching at least one keyword through a display of the terminal device when an event associated with at least one keyword among the plurality of keywords stored on the storage occurs.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram provided to explain a terminal device according to an embodiment of the present disclosure;

FIGS. 2, 3, and 4 are diagrams provided to explain a method for classifying dialogue sessions according to various embodiments of the present disclosure;

FIGS. 5 and 6 are diagrams provided to explain a method for determining dialogue sessions according to various embodiments of the present disclosure;

FIG. 7 is a diagram provided to explain a method for determining a keyword to define a dialogue session according to an embodiment of the present disclosure;

FIG. 8 is a diagram provided to explain a method for providing keywords of a terminal device according to an embodiment of the present disclosure;

FIGS. 9, 10, 11, 12, and 13 are diagrams provided to explain a method for providing dialogue sessions according to various embodiments of the present disclosure;

FIG. 14 is a diagram provided to explain a method for sharing keywords according to an embodiment of the present disclosure;

FIGS. 15A and 15B are diagrams provided to explain a method for utilizing keywords according to various embodiments of the present disclosure;

FIG. 16 is a diagram provided to explain operations between a terminal device and an external server according to an embodiment of the present disclosure;

FIG. 17 is a block diagram provided to explain a terminal device according to an embodiment of the present disclosure; and

FIG. 18 is a flowchart provided to explain a data processing method of a terminal device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While the expression such as “first” or “second” may be used to describe various constituent elements, these do not limit the constituent elements in any way. The wordings are used only for the purpose of distinguishing one constituent element from the other.

The expressions used throughout the present disclosure are used for the purpose of explaining specific embodiments, and not to be construed as limiting. The expression such as “comprise” or “consist of” as used in the present disclosure is used to designate existence of characteristic, number, step, operation, constituent element, component or a combination thereof described herein, but not to be understood as foreclosing the existence or possibility of adding one or more other characteristics, numbers, steps, operations, constituent elements, components or a combination thereof.

In describing certain embodiments of the present disclosure, the term “module” or “portion” may be provided to perform at least one or more functions of operations, and may be implemented as hardware or software, or a combination of hardware and software. Further, a plurality of “modules” or “portions” may be implemented as at least one processor (not illustrated) which is integrated into at least one module, except for a “module” or “portion” that has to be implemented as a specific hardware.

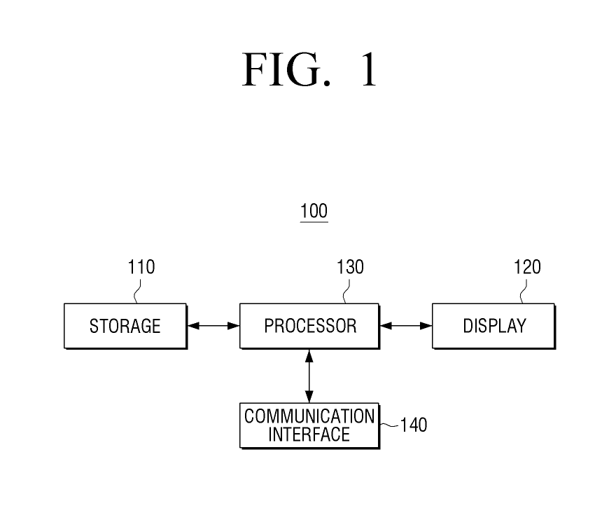

FIG. 1 is a block diagram provided to explain a terminal device according to an embodiment of the present disclosure.

Referring to FIG. 1, the terminal device 100 includes a storage 110, a display 120, a processor 130 and a communication interface 140.

The terminal device 100 may be implemented as a device which may send and receive a chatting message to and from another terminal device. For example, the terminal device 100 may be implemented to be any of various electronic devices such as a desktop computer, a smartphone, a tablet personal computer (PC), a laptop computer, a portable media player (PMP), a Moving Picture Experts Group phase 1 or phase 2 (MPEG-1 or MPEG-2) audio layer 3 (MP3) player, a television (TV), and a wearable device (e.g., smart watch). As used herein, the “chatting message” refers to any of various forms of data such as texts, sounds, or images which a user sends and receives to and from another user by using the electronic devices. These may be called with a variety of names such as “text message” for the texts, or voice message for the sounds, etc.

The storage 110 is configured to store a plurality of programs and data which are necessary for the driving of the terminal device 100. The storage 110 may be implemented to be a non-volatile memory, a volatile memory, a flash memory, a hard disk drive (HDD), or a solid state drive (SSD). The storage 110 may be accessed by the processor 130, and the processor 130 may perform reading, recording, revising, deleting and renewing regarding the data in the storage 110. According to an embodiment of the present disclosure, the term “storage” as used herein may encompass the storage 110, a read only memory (ROM) (not illustrated) and a random access memory (RAM) (not illustrated) within the processor 130 or the memory card (not illustrated) (e.g., micro secure digital (micro-SD) card or memory stick) mounted to a server.

The storage 110 may store the chatting messages sent and received to and from another terminal device and also store various pieces of information regarding the chatting messages. For example, the storage 110 may store the information regarding the chatting messages such as transmission and reception time of the chatting messages or transmitter or receiver of the chatting messages.

Further, the storage 110 may store various pieces of information stored by a user. For example, the storage 110 may store various pieces of information such as schedule information (calendar information) or yellow pages (address book) which are inputted by a user. For example, the address book may include the relationship information set by a user. For example, a user may store telephone numbers under categories such as “family” and “friend.” According to an embodiment of the present disclosure which will be described below, the schedule information and the relationship information may be used to determine a keyword regarding a dialogue session.

Further, the storage 110 may store data indicating a result of classifying the chatting messages sent and received with the other users into a plurality of dialogue sessions. Additionally, the storage 110 may further store index information regarding the location of each dialogue session. The index information regarding the location may be used to move from the current chatting screen to the chatting screen of the past dialogue session. Further, the storage 110 may store keywords for defining the respective dialogue sessions, and the keywords may be mapped respectively with the dialogue sessions and stored.

Further, the storage 110 may store images to be used as background images of the chatting screen which are classified per category. The background images on the chatting screen may be changed according to a user setting or a content of chatting dialogue. As will be described below, the processor 130 may generate a background image on the chatting screen by selecting an image suitable for the keywords defining the dialogue session.

Further, the storage 110 may store connecting information necessary for connecting the communication with the other terminal devices. In this case, the connecting information may be information regarding the encryption to directly connect between the terminal devices.

The display 120 may display various images under control of the processor 130. According to an embodiment of the present disclosure, the display 120 may be implemented to be a touch screen combined with a touch sensor. The touch sensor may be implemented in a capacitive or resistive manner. The capacitive manner refers to use of a dielectric material coated on the surface, and sensing micro electricity excited by the body of a user when a part of the user body touches on the surface of the display 120 and calculating touch coordinates. The resistive manner refers to use of two electrode plates, and sensing the electrical current flow when a user touches the screen causing the upper and the lower plates on the touched point to be brought into contact to each other and calculating touch coordinate. Accordingly, various types of touch sensor may be implemented as described above.

The display 120 may display the chatting message sent and received through the communication interface 140. According to an embodiment of the present disclosure, the display 120 may display the chatting messages classified according to dialogue sessions under controlling of the processor 130. Further, the display 130 may arrange and display the keywords stored in the storage 110.

The communication interface 140 is configured to send and receive various data to and from external devices. The communication interface 140 may be provided to connect the terminal device 100 with the external device. The external device may be connected through a local area network (LAN) and an internet network. Further, connecting may be performed according to the wireless communication methods (e.g., wireless communication such as Z-Wave, Internet protocol version 4 (IPv4) over low power wireless personal area networks (4LoWPAN), radio frequency identification (RFID), long term evolution device to device (LTE D2D), Bluetooth low energy (BLE), general packet radio service (GPRS), Weightless, Edge ZigBee, ANT+, near field communication (NFC), Infrared Data Association (IrDA), digital enhanced cordless telecommunications (DECT), wireless LAN (WLAN), Bluetooth, Wi-Fi, Wi-Fi Direct, global system for mobile communications (GSM), universal mobile telecommunications system (UMTS), LTE, wireless broadband (WiBRO), etc.).

For example, the terminal device 100 may be connected to the chatting service provider server, or also to the other terminal devices through the communication interface 140.

The processor 130 is configured to control overall operation of the terminal device 100. For example, the processor 130 may control the overall operation of the terminal device 100 using various programs stored in the storage 110. For example, the processor 130 may include central processing unit (CPU), RAM, ROM, or a system bus. As described herein, ROM is configured to store command sets for system booting. CPU may copy the stored operation system (O/S) in the storage 110 onto RAM according to the stored command in ROM, and boot the system by implementing O/S. When booting completes, CPU may copy the stored various applications on the storage 110 onto RAM, and perform various operations by implementing the copied applications. Although it is described herein that the processor 130 includes only one CPU, in actual implementation, the processor 130 may be implemented as a plurality of CPUs (digital signal processors (DSPs) or systems on chips (SoCs)).

For example, the processor 130 may classify the chatting messages sent and received through the communication interface 140 into a plurality of dialogue sessions. The “dialogue session” as used herein refers to a unit of dialogue inclusive of a plurality of chatting messages inputted by specific users for a certain time. Thus, one dialogue session may include at least two or more chatting messages.

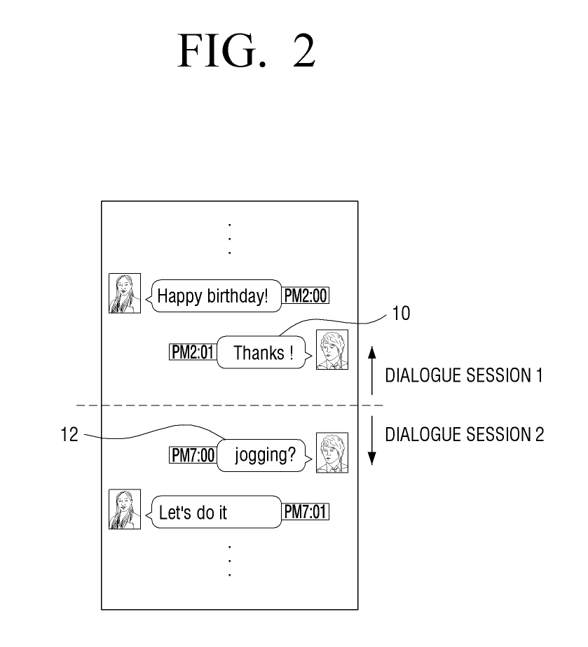

The processor 130 may classify the chatting messages sent and received through the communication interface 140 into a plurality of dialogue sessions according to various standards. For example, the processor 130 may automatically classify the dialogue sessions based on the data obtained by the chatting messages, or classify the dialogue sessions according to a user manipulation to designate the dialogue session. The following will explain a method for classifying the dialogue sessions by referring to FIGS. 2 to 4.

FIGS. 2 to 4 are diagrams provided to explain a method with which a terminal device automatically classifies dialogue sessions according to various embodiments of the present disclosure.

Referring to FIG. 2, the processor 130 may check a transmission time or a reception time of the respective chatting messages, and classify the sent and received chatting messages which exceed the certain time interval into different dialogue sessions to each other. For example, the processor 130 may determine that a new dialogue session begins when the transmission and reception time interval of the consecutive chatting messages matches or exceeds a preset time. For example, as illustrated in FIG. 2, when the interval between the transmission time (PM 2:00) of a first chatting message 10 and the reception time (PM 7:00) of a second chatting message 12 is equal to or longer than one hour, the processor 130 may determine that the dialogue session 1 is finished and the dialogue session 2 begins.

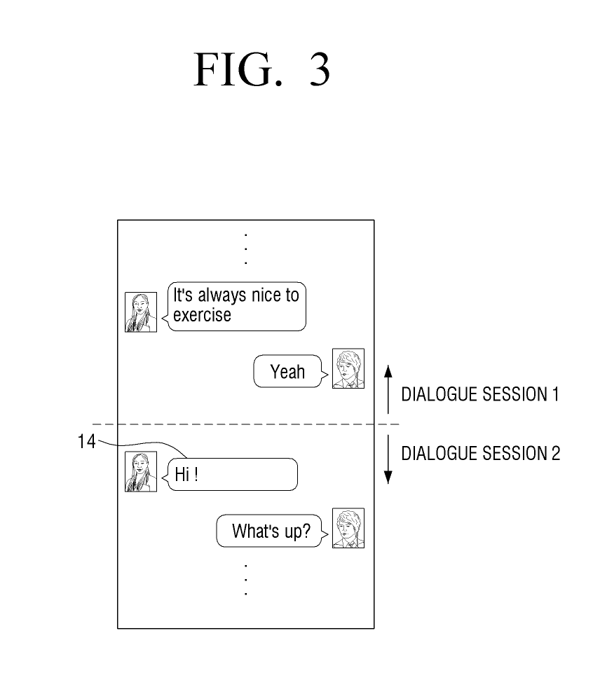

Further, referring to FIG. 3, the processor 130 may classify the dialogue sessions to be different from each other based on the time points at which the chatting messages including specific words are sent or received. For example, the storage of the terminal device 100 may store in advance data regarding topic changer words or topic changer sentences, and the processor 130 may determine that a new dialogue session begins when the chatting message includes the topic changer words or the topic changer sentences. For example, the topic changer words may be “Hi,” “What's up?” or “Hello.” As illustrated in FIG. 3, when a chatting message 14 includes the word, “Hi,” the processor 130 may determine that the dialogue session 1 is finished and the dialogue session 2 begins.

Meanwhile, data regarding the topic changer words or sentences may be manually inputted and stored one by one, or may be collected by the machine learning The “machine learning” as used herein refers to one area of the artificial intelligence, which relates to developing algorithms and technologies for the computer to learn. For example, when a user directly designates a dialogue session, the processor 130 may statistically analyze the words included in the first chatting message of the dialogue session designated by the user and learn that the words are those of the topic changer words.

According to an embodiment of the present disclosure, when a plurality of dialogue sessions are stored on the storage 110 and when the keywords regarding the plurality of dialogue sessions are associated with each other, the processor 130 may integrate the plurality of dialogue sessions into one dialogue session.

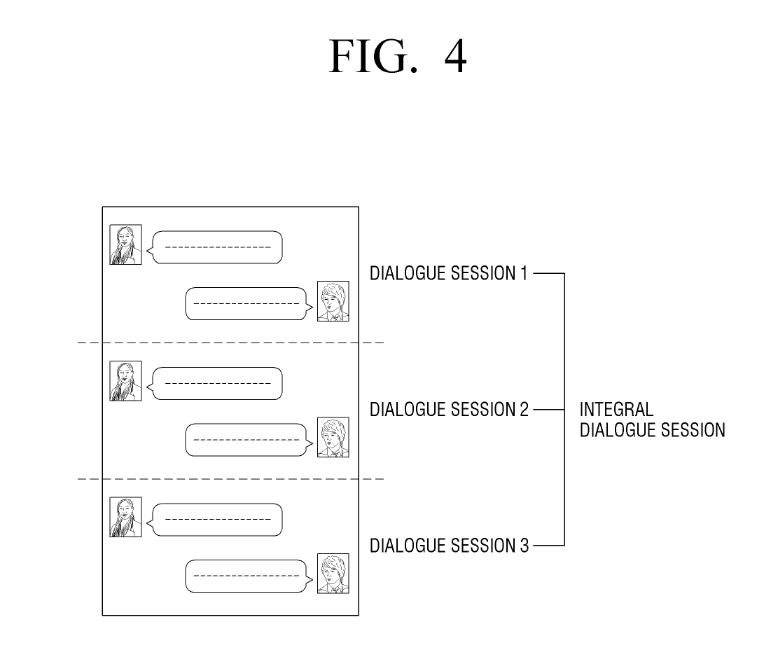

For example, referring to FIG. 4, the processor 130 may determine the dialogues 1 to 3 into one integral dialogue session based on the keyword relativity which respectively define the dialogue sessions 1 to 3. For example, as illustrated in FIG. 4, the processor 130 may determine a preset number (e.g., two) of the chatting messages to be one dialogue session, and keywords to define the dialogue sessions respectively (The method for determining keywords to define the dialogue sessions will be described below). When the keywords defining the dialogue sessions 1 to 3 are determined to be uniform or associated, the processor 130 may determine the dialogue sessions 1 to 3 to be one integral dialogue session.

Meanwhile, in this case, even when the keyword for defining the dialogue session 2 of FIG. 4 is not associated with the dialogue sessions 1 and 3, the processor 130 may determine the dialogue sessions 1 to 3 to be one integral dialogue session. This is to allow the dialogue sessions to continue without interruption even when users talk about another topic for a short moment during chatting.

For example, when the dialogue session is determined to begin (e.g., in response to inputting of a chatting message after one hour or when the topic changer words are included in the chatting message), the processor 130 may determine a preset number of the chatting messages after the dialogue session begins to be dialogue session 1, and determine a first keyword for defining the dialogue session 1. Further, the processor may determine a preset number of the chatting messages inputted thereafter to be dialogue session 2, determine a second keyword for defining the dialogue session 2, and compare the second keyword with the first keyword. When the first keyword and the second keyword are determined not to be associated with each other, the processor 130 may recognize the dialogue session 1 and the dialogue session 2 to be different from each other. Further, the processor 130 may determine a preset number of chatting messages inputted after the dialogue session 2 to be dialogue session 3, and determine a third keyword for defining the dialogue session 3. When the third keyword is determined to be associated with the second keyword as a result of comparison, the processor 130 may recognize the dialogue session 2 and the dialogue session 3 to be one session. On the contrary, when the third keyword and the second keyword are determined not to be associated with each other, the processor 130 may compare the first keyword and the third keyword. When the first keyword and the third keyword are determined to be associated with each other, the processor 130 may recognize the dialogue sessions 1 to 3 to be one integral dialogue session. According to an embodiment of the present disclosure, the effect is provided, in which all the dialogues exchanged among users may be treated as one dialogue session based on the whole context of the dialogues even when users briefly talk about different topic during chatting.

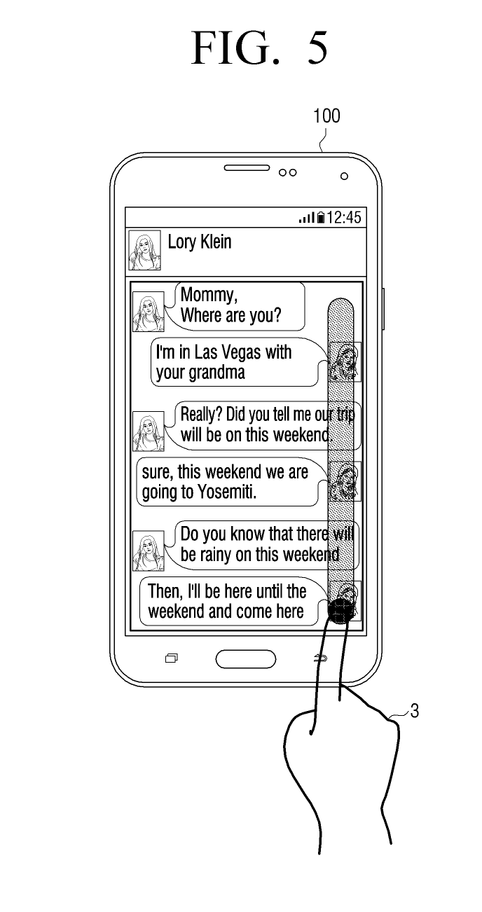

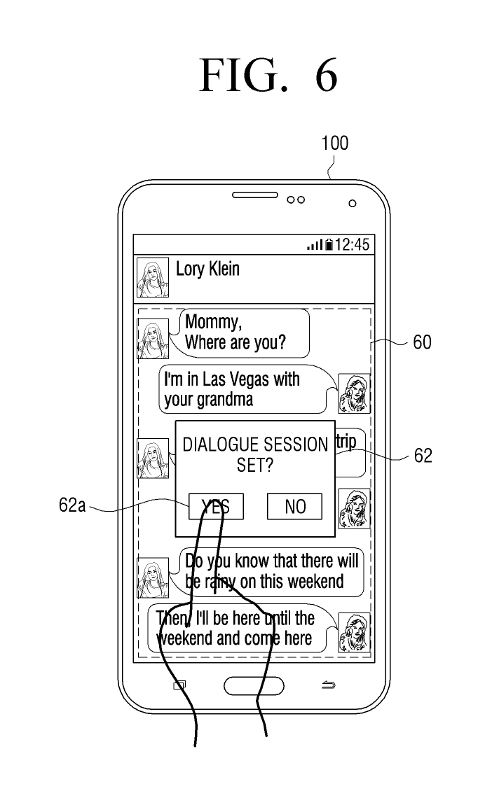

As described above, the dialogue sessions may be automatically classified by the operation of the processor 130. The following will explain an embodiment of the present disclosure in which the dialogue sessions are classified by a user by referring to FIGS. 5 to 6.

FIG. 5 is a diagram provided to explain a method for classifying a dialogue session by a user according to an embodiment of the present disclosure.

Referring to FIG. 5, the terminal device 100 includes an inputter to receive a user manipulation. The inputter may be realized in the form of a touch screen combined with the display 120. In response to input of a user manipulation to select at least part of a plurality of chatting messages displayed on the display 120, the processor 130 may determine the chatting messages within a range corresponding to the inputted user manipulation to be one dialogue session.

For example, as illustrated in FIG. 5, according to a drag manipulation 3 on the touch screen, the processor 130 may determine the chatting messages within the range corresponding to the drag manipulation 3 to be one dialogue session. The drag manipulation 3 is merely one of various embodiments of the present disclosure, and accordingly, any manipulation to designate the range of the chatting messages can be applied. According to an embodiment of the present disclosure, because the dialogue session may be determined manually by a user, an effect can be obtained in which the management of the dialogue sessions may be performed by considering the user opinion.

FIG. 6 is a diagram provided to explain a method for classifying a dialogue sessions by a user according to an embodiment of the present disclosure.

Referring to FIG. 6, when one dialogue session is finished during chatting, the processor 130 may provide a graphic effect 60 to inform of the end of the dialogue session through the display 120. Thus, the processor 130 may sense the end of the dialogue session according to the description above (e.g., sense the appearance of the topic changer words) and display the graphic effect 60. For example, the graphic effect 60 may be a flashing dotted box 60 surrounding the chatting messages included in one dialogue session, as illustrated in FIG. 6. In response to input of a user manipulation to agree with the end of the dialogue session, the processor 130 may determine the chatting messages within the range corresponding to the graphic effect 60 to be one dialogue session. In this case, as illustrated in FIG. 6, the processor 130 may display a user a user interface (UI) 62 to ask if he or she agrees with the end of the dialogue session on the display 120. In response to inputting of a user manipulation to select OK in a menu 62a, the processor 130 may determine the chatting messages within the box as the graphic effect 60 to be one dialogue session.

When the dialogue session is determined, the processor 130 may determine a keyword for defining the dialogue session by analyzing the chatting messages within the dialogue session. The following will explain a method for determining the keyword for defining the dialogue session.

The “keyword for defining the dialogue session” as used herein refers to index information used for searching the dialogue session. The term “keyword” as used herein may be used to indicate a combination of two or more words or sentences as well as one word according to an embodiment of the present disclosure. The determined keyword may be shared with another user of the other terminal devices, which may be further described below.

There may be one or more keywords for defining the dialogue session. For example, the keyword may be determined based on at least one of a dialogue participant, a dialogue time, a dialogue subject, words associated with the dialogue, and an intent of the dialogue regarding the dialogue session. The “dialogue participant” may refer to a transmitter or a receiver of the chatting messages, and the “dialogue time” may refer to a time taken for the chatting messages within the dialogue session to be sent and received or a time period mentioned in the chatting messages. The “dialogue associated words” may refer to words/sentences included in the chatting messages of the dialogue session, or superordinate or associated words regarding the words/sentences. For example, when the words such as “Galaxy S5” and “Galaxy Note” are mentioned in the dialogue session, the superordinate word may be determined to be keyword such as “smartphone”. Further, the “dialogue intention” may refer to the user intention for the objective words, which may be classified mainly by analyzing the verbs of the sentences. For example, when the dialogue topic is “travel” and the intention is “to go”, the user intention may be determined to be a travel schedule plan across the whole context of the dialogue.

For example, the processor 130 may analyze the chatting messages included in the dialogue session, and extract the entity and the intention of the chatting message sentences by using the natural language understanding (NLU), the data mining, etc. NLU is one area of the artificial intelligence which processes the machine reading comprehension. NLU and the data mining can be easily understood in the art, which may not be further described herein.

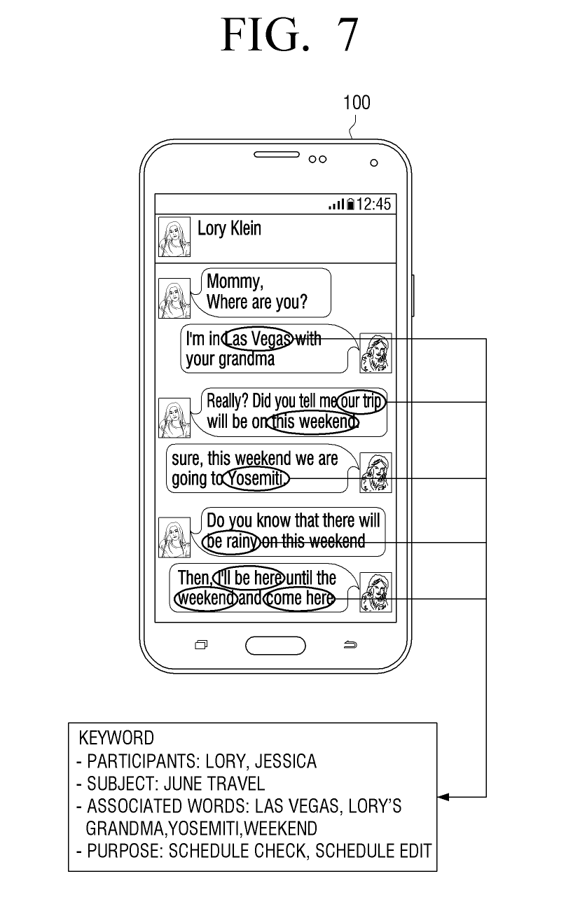

During extracting, a semantic may be used, social relation information (e.g., a phone book or a social networking service (SNS)) previously stored in the storage 110 may be used regarding the persons in order to enhance the clarity of the extracting, and the schedule information previously stored in the storage 110 may be used regarding the schedule. The following will explain a process of determining the keyword by referring to FIG. 7.

FIG. 7 is a diagram provided to explain a method for determining a keyword to define a dialogue session according to an embodiment of the present disclosure.

Referring to FIG. 7, the processor 130 may extract and analyze the words/sentences from one determined dialogue session such as “Las Vegas”, “Your grandma”, “our trip”, “this weekend”, “Yosemite”, “be rainy”, “I'll be here”, “weekend”, or “come here”, and determine the following keywords by analyzing the extracted words/sentences. For example, “Lory” and “Jessica” may be determined as participant keywords, “June travel” may be determined as subject keywords, and “Las Vegas”, “Lory's grandma”, “Yosemite”, and “weekend” may be determined as associated words. In this case, Lory's grandma may be determined based on the word “your’. Thus, the keyword may be determined by considering the transmitter or receiver of the chatting messages. Further, the schedule change and the schedule check may be determined as dialogue intention keyword.

Meanwhile, when the storage 110 of the terminal device 100 stores the travel schedule for this weekend among the previously stored schedule information, the processor 130 may extract the keyword “travel” from the word “this weekend”. Further, when the persons are mentioned in the dialogue session, the processor 130 may determine the relation between the persons mentioned in the dialogue session and the users inputting the chatting messages to be keywords by using the phone book (address book) previously stored in the storage 110. For example, when the chatting message includes “James”, and when “James” is designated as a younger brother based on the relation information of the phone book, the keywords “younger brother” and “family” may be extracted. As well as a phone book, the information regarding the social relations registered on SNS may be used in determining the keyword.

Further, the relation information regarding whether the dialogue participant is a recently acquainted one or not, or for how long the dialogue participant has been acquainted may be classified based on the frequency at which a user sends and receives the chatting messages. As such, the processor 130 may determine the keyword based on the above-mentioned information.

Meanwhile, the range of expanding the keyword may depend on a user setting. For example, a user may set as to whether to expand the keyword by using the social relation information on the phone book or SNS or to expand the keyword into the superordinate concept of the extracted keywords.

Meanwhile, according to an embodiment of the present disclosure, the terminal device 100 may further include a sensor (not illustrated) to sense at least one state among a location of the terminal device 100, a movement of the terminal device 100, an ambient temperature of the terminal device 100, and an ambient humidity of the terminal device 100.

For example, the terminal device 100 may include a global positioning system (GPS) receiver. The GPS receiver may receive GPS signals from a GPS satellite, and calculate the current location of the terminal device 100.

Further, the processor 130 may determine the movement of the terminal device 100 through a motion recognizing sensor provided on the terminal device 100. The motion recognizing sensor may sense the posture changes based on at least one axis among the three dimensional axes. For example, the motion recognizing sensor may be implemented as various sensors such as a gyro sensor, a geomagnetic sensor, or an acceleration sensor. The acceleration sensor may output a sensing value corresponding to the gravity acceleration which changes according to the inclination of the device mounted with the sensor. The gyro sensor may measure a Coriolis force applied toward the velocity direction when the rotating is performed, and calculate the angular velocity. The geomagnetic sensor may sense the azimuth.

Further, the processor 130 may determine the ambient temperature and the ambient humidity of the terminal device 100 through a temperature and/or humidity sensor provided on the terminal device 100.

The terminal device 100 may determine the state of the terminal device 100 with the above various units, and use the state information in determining the keyword of the dialogue session.

For example, the processor 130 may determine the keyword to define the dialogue session that includes the inputted chatting messages based on the information sensed through the sensor at the moment when the chatting messages are inputted. For example, when a user inputs a chatting message “I'm here to see my friend” by using the terminal device 100 at Gangnam-gu, which is a southern district of South Korea, the processor 130 may recognize that the location of the terminal device 100 is Gangnam-gu, when the chatting message is inputted through GPS receiver. Thus, the keyword to define the dialogue session at the time point when the chatting message is inputted may include Gangnam-gu.

For another example, the processor 130 may analyze the movement information of the terminal device 100 by using the gyro sensor or the gravity sensor at the moment when the chatting messages are inputted, and determine whether a user is exercising. Thus, even when there is no information regarding exercising in the chatting messages, the keyword to define the dialogue session at the time point when the chatting message is inputted may include “exercising”.

For another example, the processor 130 may obtain the surrounding environment information of the terminal device 100 at the time point when the chatting message is inputted through the temperature and/or humidity sensor. Based on the above, even when there is no information regarding the weather in the chatting message, “rainy” or “hot” may be selected as a keyword to define the dialogue session at the time point when the chatting message is inputted.

According to various embodiments of the present disclosure including those described above, the whole context of the dialogue generated by the chatting messages can be understood because the chatting messages may be comprehensively analyzed based on various pieces of information rather than simply analyzing the texts.

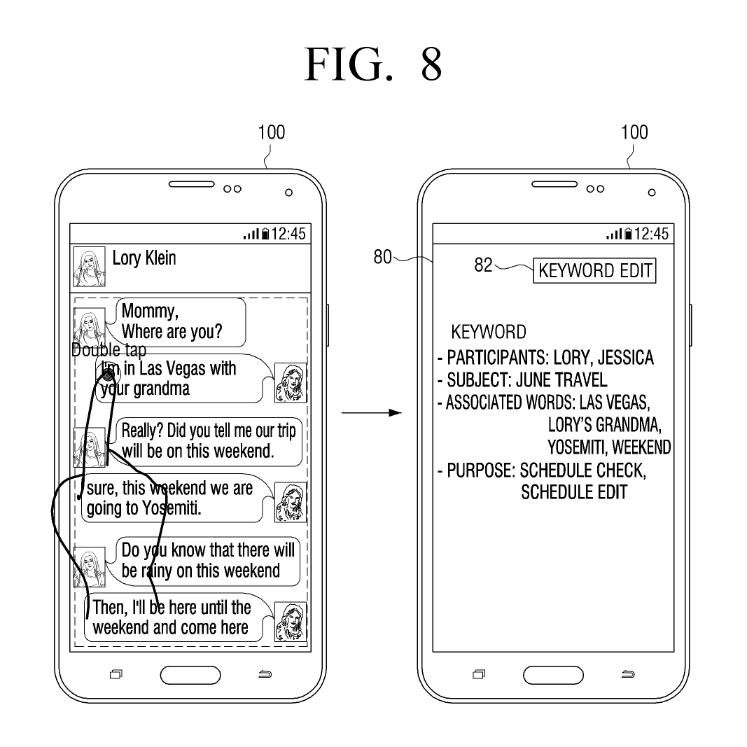

The processor 130 may store the keywords to respectively define the classified dialogue sessions on the storage 110. Further, the processor 130 may provide the determined keywords to a user, or update the keywords according to a user manipulation to edit the determined keywords. The above may be further described below by referring to FIG. 8.

FIG. 8 is a diagram provided to explain a method for providing keywords of a terminal device according to an embodiment of the present disclosure.

Referring to FIG. 8, the processor 130 may display the keyword regarding the determined dialogue session in response to inputting of a preset user manipulation after the dialogue session is determined. For example, as illustrated in FIG. 8, in response to inputting of a user manipulation of double-tapping the area where the chatting messages within the dialogue session are displayed, the processor 130 may display UI 80 including the keyword list to define the dialogue session corresponding to the tapped area. A user may confirm at least one keyword to define the dialogue session through UI 80, delete the keyword or add a new keyword. For example, when an edit menu 82 is selected, the keywords within UI 70 may be changed into an editable form.

When an event associated with at least one keyword among the plurality of keywords stored on the storage 110 occurs, the processor 130 may provide the dialogue session matching at least one keyword through the display 120.

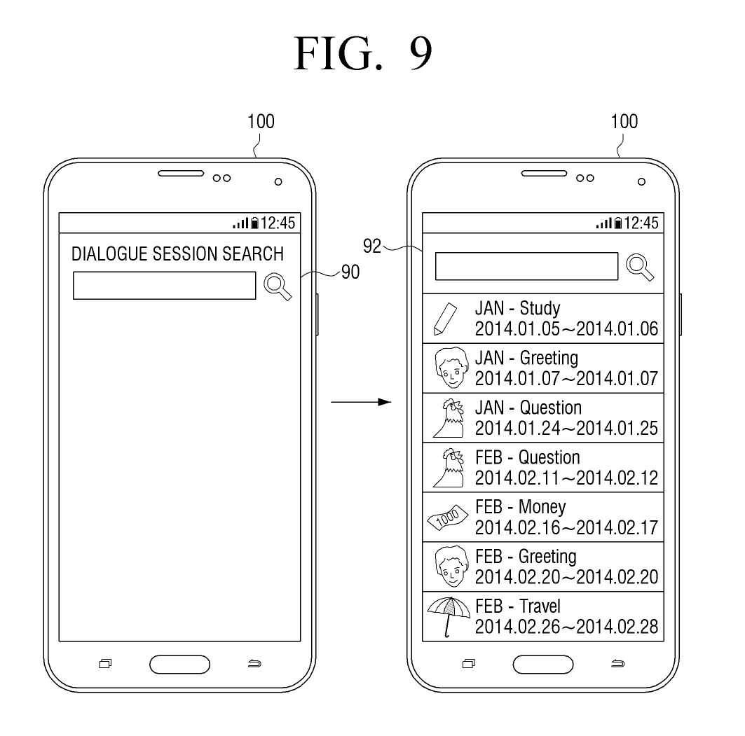

For example, when an event to input the keyword to search the dialogue session occurs, the processor 130 may display the dialogue session list corresponding to the inputted keyword on the display 120. The above may be further described below by referring to FIG. 9.

FIG. 9 is a diagram provided to explain a method for providing a dialogue session according to an embodiment of the present disclosure.

Referring to FIG. 9, the processor 130 may display UI 90 to search a dialogue session on the display 120, and a user may search the dialogue session through the UI 90. One or more keywords for searching the dialogue session may be inputted, and these may be associated with participant, topic, time, or intention of the dialogue session.

The processor 130 may control the display 120 to display a list UI 92 of the dialogue session corresponding to the inputted keyword. The list UI 92 may include images representing the dialogue session, a date when the dialogue is made, or information regarding the dialogue participant.

In the keyword-searching, the processor 130 may use the relation data stored on the storage 110. For example, in response to inputting of the keyword “friend”, the processor 130 may search and provide the dialogue sessions in which the persons designated as friends of a user are mentioned based on the relation information included in the phone book stored on the storage 110. Further, the processor 130 may provide the searching result based on the information regarding the frequency of the dialogues. For example, in response to inputting of the search term “stranger”, the processor 130 may search and provide the dialogue sessions in which the persons who rarely exchanged dialogues are mentioned or the dialogue sessions in which the persons who rarely exchanged the dialogue are dialogue participants themselves. For another example, in response to inputting of the keyword “smartphone, the dialogue sessions including the subordinate words such as “Galaxy S5” or “Galaxy Note” may be searched and provided.

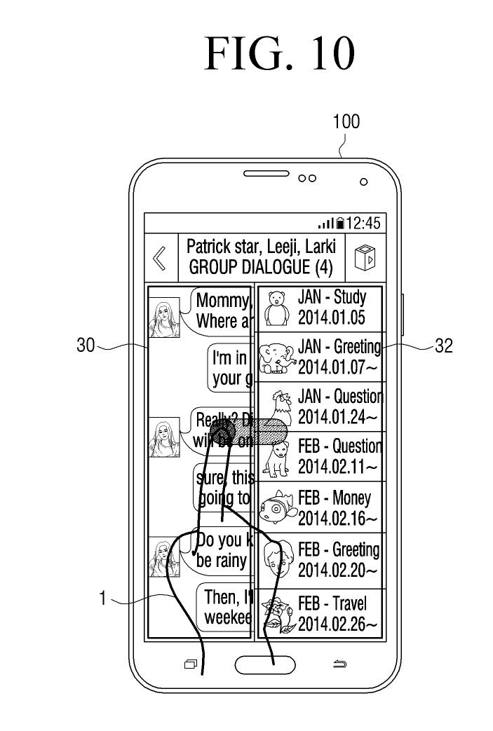

FIG. 10 is a diagram provided to explain a method for providing a dialogue session according to an embodiment of the present disclosure.

Referring to FIG. 10, the processor 130 may respectively display chatting area 30 and associated dialogue session area 32 on the screen of the display 120, and display the chatting messages sent and received through the communication interface 140 on the chatting area 30, and in response to occurrence of an event of displaying one of the stored keywords on the storage 110 on the chatting area 30, the processor 130 may display the dialogue session matching the displayed keyword on the associated dialogue session area 32. For example, simultaneously with inputting of the chatting message including “the study” by a user, the processor 130 may display the dialogue session list matching the “study” on the associated dialogue session area 32.

Further, the processor 130 may respectively display the chatting area and the associated dialogue session area on the screen of the display 120, and display the chatting messages sent and received through the communication interface 140 on the chatting area 30, and in response to an occurrence of an event in which the keyword of the dialogue session inclusive of the chatting messages displayed on the chatting area 30 corresponds to the previous keyword stored on the storage 110, the processor 130 may display the dialogue session matching the previous keyword on the associated dialogue session area 32. According to an embodiment of the present disclosure, the past dialogue session suitable for the dialogue topic about which the chatting is currently performed may be provided.

According to the embodiment of the present disclosure described above, when the inputter 140 is implemented as a touch panel, the associated dialogue session area 32 may be displayed on the screen in response to a swipe manipulation 1. Further, the associated dialogue session area may be displayed in a bloom shape.

When a user selects one from a dialogue session list displayed on the associated dialogue session area 32, the processor 130 may display the selected dialogue session on the whole area of the associated dialogue session area 32. Otherwise, the processor 130 may display the selected dialogue session on the whole area of the screen.

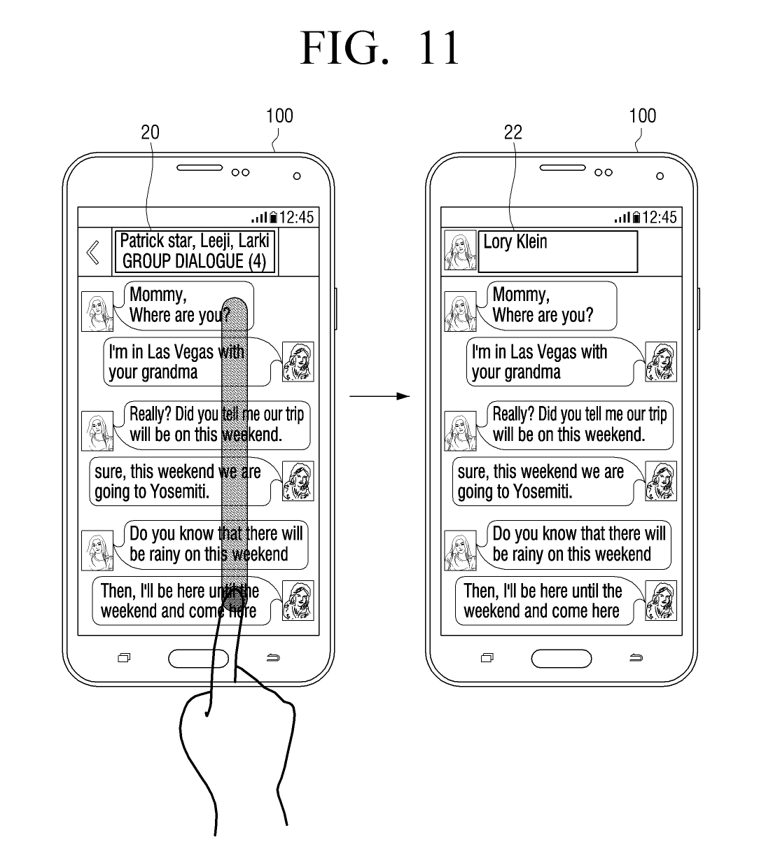

Meanwhile, according to an embodiment of the present disclosure, in response to inputting of a user manipulation to select the dialogue session, the processor 130 may display a new chatting screen inclusive of the chatting messages within the selected dialogue session on the display 120. The above may be described below by referring to FIG. 11.

FIG. 11 is a diagram provided to explain a method for generating a new chatting screen with a dialogue session according to an embodiment of the present disclosure.

Referring to FIG. 11, a user may designate the dialogue session by directly dragging as described in FIG. 5. Further, the processor 130 may generate and display a new chatting screen with the dialogue session designated by a user on the display 120. Thus, as illustrated in FIG. 11, a new two-person chatting room 22 may be generated by copying the chatting messages shared in a group chatting room 20. According to an embodiment of the present disclosure, a user may generate new chatting screen by selecting the necessary portion on the current chatting screen. Thus, when a first dialogue participant and a second dialogue participant are sending and receiving the chatting messages on the chatting dimension for the group dialogue and when a third participant is not interested in the dialogue, the first dialogue participant and the second dialogue participant may copy the dialogue and generate a new chatting screen, so that the dialogue can be continued in the dimension for the two persons.

Further, a new chatting screen may be generated according to a method described as follows. For example, as described with reference to FIG. 9, a user may be provided with the list of the dialogue sessions corresponding to the searching word by inputting the searching word. Further, as described with reference to FIG. 10, a user may be provided with the list of the dialogue sessions on one area of the screen while the current chatting is performed. Thereafter, a user may generate new chatting screen with the selected dialogue session by selecting one dialogue session on the provided list.

According to the above embodiments of the present disclosure, a user may pick up the dialogue from the past dialogue session, in addition to simply reading the past dialogue session.

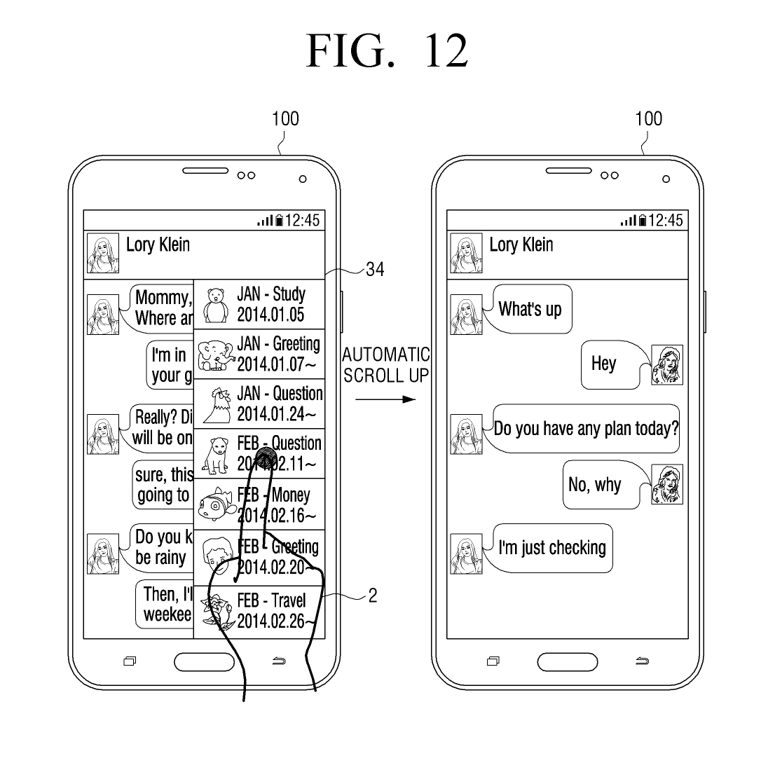

FIG. 12 is a diagram provided to explain a method for providing the dialogue session according to an embodiment of the present disclosure.

Referring to FIG. 12, the past chatting messages move up and disappear whenever a new chatting message is inputted on the chatting screen. In response to inputting of a user manipulation 2 to select a specific dialogue session on the chatting screen 34 in which the current chatting is performed, the processor 130 may control the display 120 to automatically scroll the current chatting screen toward the selected dialogue session.

For example, the storage 120 may store the location information of the dialogue session on the chatting screen as well as keywords for defining the dialogue session. Thus, the processor 130 may automatically scroll toward the past dialogue session based on the location information. According to an embodiment of the present disclosure, in addition to the quickly moving toward the past dialogue session, a user may easily confirm the dialogues before and after the dialogue session.

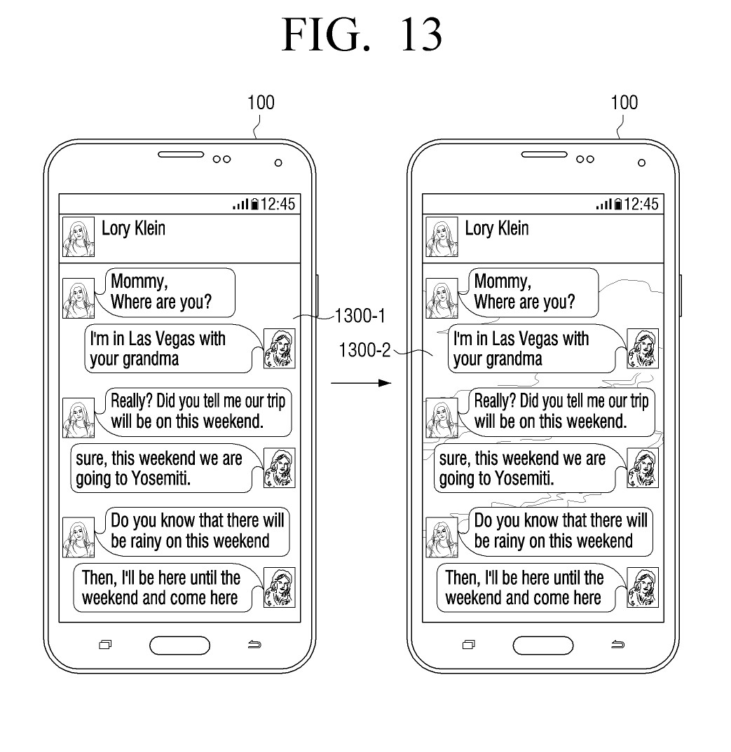

Meanwhile, according to the above various embodiments of the present disclosure, various operations may be performed by using the keywords defining the dialogue session. For example, while the chatting messages within the specific dialogue session are displayed on the chatting screen, the processor 130 may control the display 120 to display the keywords defining the specific dialogue session and the associated background images on the chatting screen. The above will be described below by referring to FIG. 13.

FIG. 13 is a diagram provided to explain the process of converting a background images on the chatting screen according to an embodiment of the present disclosure.

Referring to FIG. 13, when the dialogue session is determined (e.g., in response to appearance of the topic changer word/sentence), the processor 130 may determine the keyword for defining the determined dialogue session and search the image corresponding to the determined keyword on the storage 110. Further, the processor 130 may display the searched image on the chatting screen as a background image. In this case, when there are a plurality of keywords for defining the dialogue session, the keyword regarding the subject of the dialogue session may be selected as a keyword used in searching the image. Thus, when the subject keyword for defining the current dialogue session is “travel”, the current background image 1300-1 may be changed into the background image 1300-2 suitable for the travel. Meanwhile, according to an embodiment of the present disclosure, instead of displaying the background image on the whole area of the screen, the smaller image associated with the keyword may be displayed on a portion of the screen, such as an upper portion of the screen. According to an embodiment of the present disclosure, a user may be provided with the chatting background screen of the images suitable for the dialogue subject with which the chatting is currently sharing.

Meanwhile, according to an embodiment of the present disclosure, the processor 130 may arrange and display the keywords stored on the storage 110 on the display 120. In this case, the processor 130 may display the keywords on the display 120 according to the order of the most frequently used keywords in defining the dialogue session, i.e., according to the popularity order. Further, the processor 130 may display the popular keywords by expanding the size of the character on the display 120. Otherwise, the keywords may be organized and displayed according to the statistical order. For example, under the upper category of the travel, the business trip, the family travel, and the vacation may be organized and displayed as lower categories.

According to the above embodiment of the present disclosure, a user may recognize the dialogue subject of his or her previous dialogues at a glance through the keyword, and can also be made aware of the subject that he or she mainly discussed in the dialogue.

Further, in response to inputting of a user manipulation to select any one keyword among the arranged and displayed keywords, the processor 130 may search and display the dialogue session corresponding to the selected keyword on the display 120.

Meanwhile, according to an embodiment of the present disclosure, the keywords may be shared with the other terminal devices. The shared keywords may be used in various operations of the terminal device 100. For example, the terminal device 100 may send and receive the keywords through the communication interface 140 with the other terminal devices. Herein, the terminal device 100 may directly perform communication with the other terminal devices, which can thus prevent inadvertent leaking of keywords externally.

According to an embodiment of the present disclosure, the processor 130 may receive the keywords stored in another terminal device through the communication interface 140, and determine the popular keywords based on the received keywords and the stored keywords on the storage. Herein, another terminal device may also classify the dialogue sessions and determine the keywords of the classified dialogue sessions. Further, the terminal device 100 may share the keywords with a plurality of other terminal devices. The popular keywords may refer to frequently used keywords in defining the dialogue session in the terminal device 100 and another terminal device. Thus, the popular keywords may refer to the common interests of a user and another user.

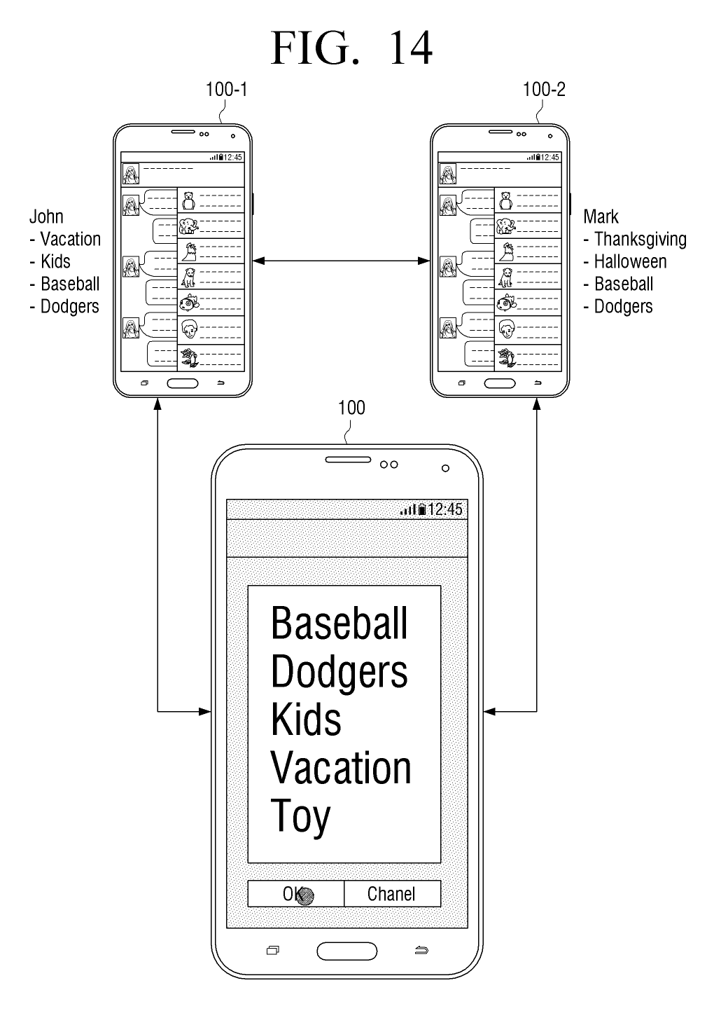

The popular keywords may be arranged and displayed on the display 120, which may be described below by referring to FIG. 14.

FIG. 14 is a diagram provided to explain a method for sharing keywords according to an embodiment of the present disclosure.

Referring to FIG. 14, the terminal device 100 may be connected to the terminal device 100-1 of “John” and the terminal device 100-2 of “Mark”, and may share the keywords. Meanwhile, a user may set the restriction on the sharing regarding the keywords which a user does not want to share. The processor 130 may analyze the shared keywords, recognize the words “Baseball” and “Dodgers” as common keywords, and determine these words to be popular keywords. The processor 130 may arrange and display the shared keywords on the display 120, or mark the words “Baseball” and “Dodgers” which are determined to be popular keywords with priority. Further, when the keywords are displayed, the processor 130 may consider the user who is transmitting the keywords. Thus, when the keywords are sent from the friends, the processor 130 may mark these with “my friends' common interest”. When the keywords are sent from the local neighbors, the processor 130 may mark the keywords with “my neighbors' common interest”. The phone book or SNS social relation information may be used in recognizing the users transmitting the keywords.

According to an embodiment of the present disclosure, a user may confirm the dialogue subject in which the friends send and receive during chatting. More specifically, the processor 130 may determine the popular keywords per age or per local area by using the previously stored social relation information. In this case, the social relation information may be relation information of the phone book stored on the storage 110 or SNS information.

Meanwhile, according to an embodiment of the present disclosure, the processor 130 may display automatically-suggested words on the display while the text is inputted through the inputter 140, and the displayed automatically-suggested words may be selected from the above described popular keywords. The automatic word suggestion function may refer to a function to suggest the words to a user while the text is inputted on the terminal device 100. Thereby, a user may input the text by selecting the suggested words even when before completely inputting the intended text. According to an embodiment of the present disclosure, the above popular keywords may be suggested as automatically-suggested words.

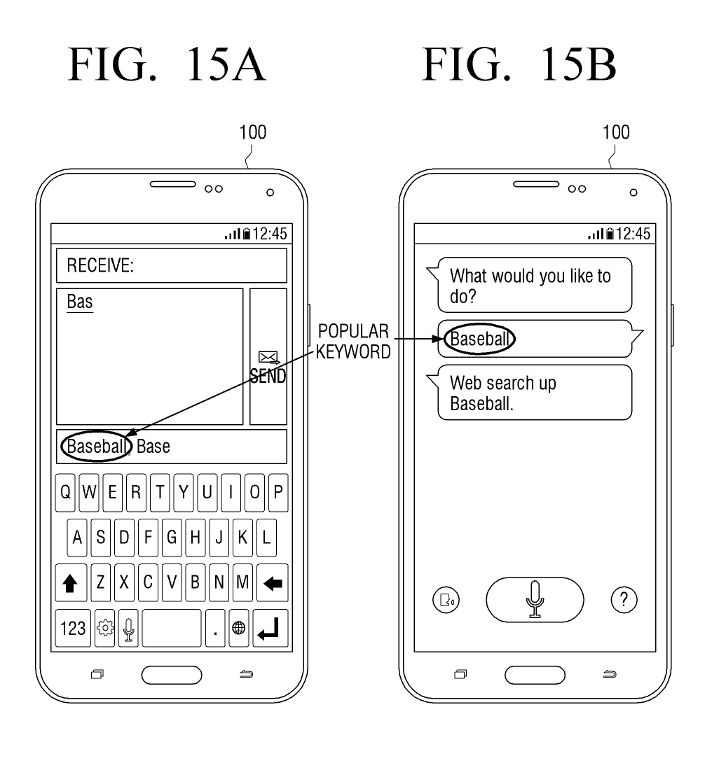

For example, the processor 130 may put weight on the words corresponding to the popular keywords among the automatically-suggested words so that the processor 130 displays the words on the higher rank of the suggested words. The above may be described below by referring to FIGS. 15A and 15B.

FIGS. 15A and 15B are diagrams provided to explain a method for utilizing keywords according to various embodiments of the present disclosure.

Referring to FIG. 15A, when a user inputs the text, the processor 130 may control the display 120 to display various automatically-suggested words, and display the keywords determined as popular keywords on the front among the shared keywords. For example, in a normal use environment, input of a partial word “Bas” may first cause suggestion of “Base” as an automatically-suggested word. However, according to an embodiment of the present disclosure, “Baseball” which is determined as a popular keyword may be first suggested.

The function described above may be also applied to voice recognizing in addition to text inputting.

Referring to FIG. 15B, if a voice input matches a plurality of corresponding words in the voice recognition, the processor 130 may give greater weight to a word corresponding to the popular keyword. For example, a user may speak the word “Baseball” while the terminal device 100 may determine the voice input to be any one of “Baseball” and “Basement”. In this case, because the popular word “Baseball” has the greater voice recognition weight, the terminal device 100 may recognize the voice input as “Baseball”.

According to the above embodiment of the present disclosure, when inputting a text or a voice command, the words corresponding to the subjects in which a user and his friends are interested may be first suggested or classified. Thus, the words representing the user interest may be first suggested.

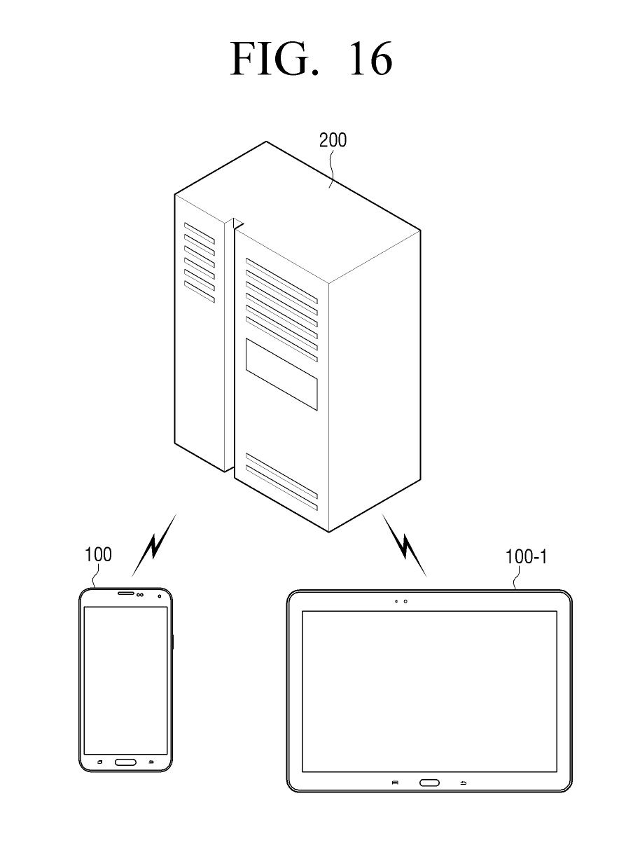

Although the above explains that the processes of classifying the dialogue session and determining the keyword for defining the dialogue session may be performed in the terminal device 100, such processes may be also performed by the external server. In this case, the external server may inform the processing result of the terminal device 100. This embodiment of the present disclosure may be explained below by referring to FIG. 16.

FIG. 16 is a diagram provided to explain operations between a terminal device and an external server according to an embodiment of the present disclosure.

Referring to FIG. 16, the terminal device 100 may receive a chatting message inputted from another terminal device 100-1 in communication with an external server 200. Further, the chatting message inputted from the terminal device 100 may be sent to the other terminal device 100-1 through the external server 200. The external server 200 may be implemented as a server providing the chatting service.

The external server 200 may classify the chatting messages received from the terminal device 100 and the other terminal device 100-1 into a plurality of dialogue sessions. Further, the external server 200 may store the keywords for defining the respective classified dialogue sessions on the internal storing unit. Thus, the above described operation of the terminal device 100 may be performed by the external server 200. The external server 200 may include the storage, the communication interface and the processor which perform the uniform operation to those of the above terminal device 100. This operation will not be redundantly described below for the sake of brevity.

Meanwhile, the terminal device 100 and the other terminal device 100-1 may transmit the keywords for defining the dialogue sessions to the external server 200. The external server 200 may analyze the interest area of the users of the terminal device 100 and the other terminal device 100-1 and extract the popular keywords by analyzing the sent keywords. The extracted popular keywords may be provided to the terminal device 100 and the other terminal device 100-1 and used in various manners. For example, the popular keywords may be used in the automatic word suggestion function, as described above.

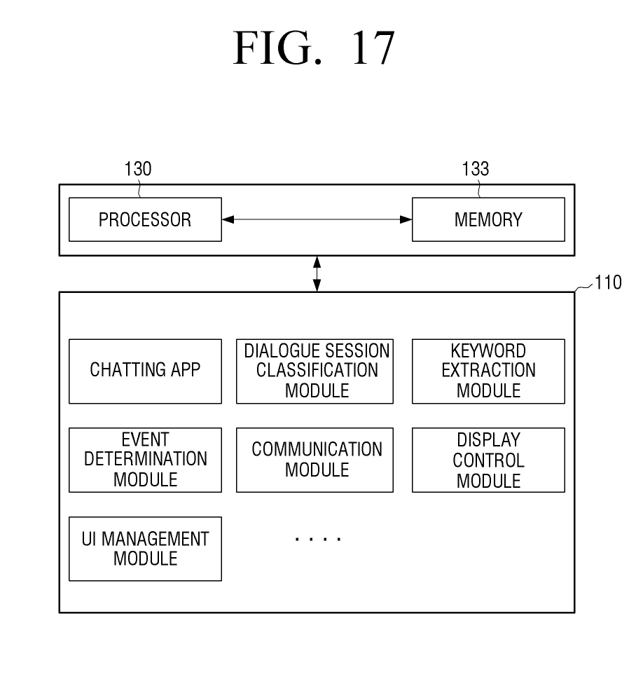

FIG. 17 is a block diagram provided to explain a terminal device according to an embodiment of the present disclosure.

Referring to FIG. 17, the processor 130 may be implemented as a CPU or a microcomputer (micom). Further, the memory 133 may include a CPU, a RAM, or a ROM. Herein, the ROM is configured to store command sets for system booting. The processor 130 may copy the stored O/S on the storage 110 to RAM according to the stored commands, and boot the system by implementing O/S. When the booting completes, the processor 130 may copy the various applications stored on the storage 110 to RAM, and perform various operations by implementing the copied applications. Although the processor 130 is described herein as one CPU, the processor 130 may be implemented as a plurality of CPUs (DSPs or SoCs) when actually implemented.

The storage 110 may include various programs and modules necessary for driving the system. For example, the storage 110 may store a chatting application, a dialogue session classification module, a keyword extraction module, an event determination module, a communication module, a display control module, or a UI management module.

The chatting application is a program that allows to send and receive the chatting messages with the other terminal devices. The dialogue session classification module is provided to classify the sent and received chatting messages into the plurality of dialogue sessions. Further, the keyword extraction module is provided to extract the keywords within the chatting message. For example, the keyword extraction module may extract the associated keywords that can be inferred from the words included in the chatting message as well as the words included in the chatting message. The event determination module is provided to determine whether a preset event occurs. For example, the event to input the stored keywords on the storage 110 may be determined by the event determination module. The communication module is provided to connect the terminal device 100 to the external device. For example, the communication module may be used in recognizing the other terminal devices or the external server as external devices and connect the external devices to the terminal device 100. Through the communication module, the other terminal devices and the terminal device 100 may send and receive the data through peer to peer (P2P). The display control module is a module to be used in generating a screen displayed on the display 120. Further, the UI management module is a module to manage UI displayed on the display 120 and store various UI templates.

With the terminal device 100 and the external server 200 according to the above described embodiments of the present disclosure, analyzing may be performed based on the dialogue session unit including the plurality of chatting messages rather than analyzing a single chatting message in which the users send and receive. Thus, the whole dialogue context can be classified by using NLU technology. Further, according to the above embodiments of the present disclosure, because the dialogue classifying time point may be determined similarly to the user dialogue, the dialogue context can be classified more correctly.

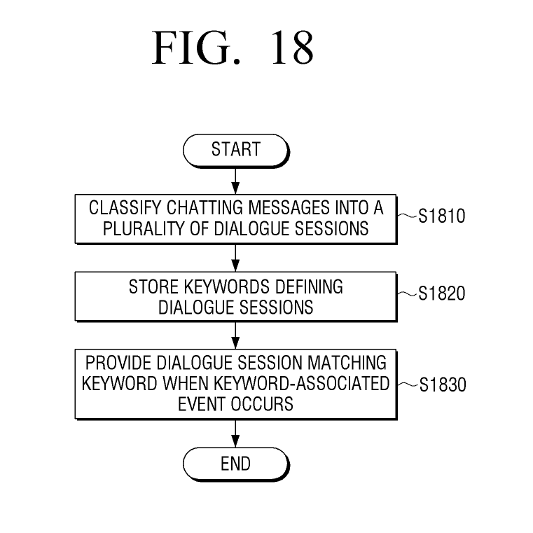

The following will explain a data processing method of the terminal device according to an embodiment of the present disclosure by referring to FIG. 18.

FIG. 18 is a flowchart provided to explain a data processing method of a terminal device according to an embodiment of the present disclosure.

Referring to FIG. 18, the terminal device 100 may classify the chatting messages into a plurality of dialogue sessions, at operation S1810. The chatting messages may be sent and received directly with the other terminal devices or from the server providing the chatting service. The chatting messages of the users of the terminal device and the other terminal devices may be continued without classifying. However, according to an embodiment of the present disclosure, the chatting messages may be classified based on the unit of dialogue into the plurality of dialogue sessions. The standard to classify the chatting messages may be whether the specific word is included in the chatting message or time interval when the continued chatting messages are sent and received.

At operation S1820, the terminal device 100 may store the keywords respectively for defining the classified dialogue sessions on the storage of the terminal device 100. In this case, the keywords for defining the dialogue sessions may be selected from the words included within the dialogue session, or may be new word according to the combination of the words included within the dialogue session. For example, the keywords may be determined from the participant, the subject, the intention and the time regarding the dialogue session.

When the event associated with at least one keyword among a plurality of keywords stored on the storage of the terminal device 100 occurs, the terminal device 100 may provide the dialogue session matching at least one keyword, at operation S1830. The event associated with the keyword may be an event to search the dialogue session, the event to correspond with the keyword included in the chatting message sent and received at real time to the keyword stored on the storage, or an event to determine the keyword for defining the dialogue session after the dialogue session inclusive of the plurality of chatting messages is determined, Further, the terminal device 100 may provide the dialogue session by displaying the list regarding the plurality of dialogue sessions on the display or by displaying the chatting messages within one dialogue session on the display.

Further, the terminal device 100 may use the keywords defining the dialogue sessions in the various functions. As described above, the terminal device 100 may provide the keywords to a user through the display, or provide the interest area of the users of the terminal device and the other terminal devices by sharing the keywords with the other terminal devices. Further, the terminal device 100 may extract the popular keywords from the shared keywords and use in the automatic word suggestion function. These embodiments of the present disclosure are already described above, which may not be further explained below within the overlapping range.

Meanwhile, although it is described herein that data processing is performed by the terminal device 100, the operation may be uniformly performed by the server providing the chatting service. In this case, the server may be implemented as a device that can classify the chatting messages into the plurality of dialogue sessions. Further, the server may receive the information regarding the event occurring in the terminal device, and provide the dialogue session corresponding to the event to the terminal device.

With data processing methods according to the above various embodiments of the present disclosure, a user may easily find a chatting dialogue made with other users in the past according to subject, time, dialogue participant and dialogue intention.

Data processing methods according to the above various embodiments of the present disclosure may be implemented as a program including algorithms that can be run on a computer, and the program may be stored and provided in the non-transitory computer readable recording medium. The non-transitory computer readable recording medium may be loaded on various devices.

The non-transitory computer readable recording medium indicates a medium that stores data semi-permanently and can be read by devices, not a medium storing data temporarily such as a register, a cache, or a memory. For example, the above various applications or programs may be stored and provided in non-transitory computer readable recording medium such as a compact disc (CD), a digital versatile disc (DVD), a hard disk, a Blu-ray disc, a universal serial bus (USB), a memory card, or a ROM.

Therefore, the above program may be installed on the related devices, and the terminal device or the server that can classify and manage the chatting messages by the dialogue sessions may be implemented.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A terminal device comprising:
a communication interface configured to perform communication with an external device as chatting begins;
a display configured to display chatting messages sent and received through the communication interface;
a storage; and
a processor configured to:
classify the chatting messages into a plurality of dialogue sessions,
store keywords for defining the respective classified dialogue sessions on the storage, and
provide the dialogue session matching at least one keyword through the display when an event associated with at least one keyword among the plurality of keywords stored on the storage occurs.

2. The terminal device of claim 1, wherein the processor is further configured to:
check a transmission time or a reception time of the respective chatting messages, and
classify the chatting messages which are sent and received for a duration that exceeds a certain time interval into different dialogue sessions to each other.

3. The terminal device of claim 1, wherein the processor is further configured to classify the dialogue sessions into different dialogue sessions based on a time point of sending or receiving the chatting message including a specific word.

4. The terminal device of claim 1, wherein the processor is further configured to integrate the plurality of dialogue sessions into one dialogue session when the plurality of dialogue sessions are stored on the storage and the keywords regarding the plurality of dialogue sessions are associated with each other.

5. The terminal device of claim 1, wherein, in response to inputting of a user manipulation to select at least part of the plurality of chatting messages displayed on the display, the processor is further configured to determine the chatting messages within a range corresponding to the inputted user manipulation to be one dialogue session.

6. The terminal device of claim 1, wherein the processor is further configured to:
provide a graphic effect to inform of an end of the dialogue session through the display when one dialogue session is finished during chatting, and
determine the chatting messages within a range corresponding to the graphic effect to be one dialogue session in response to inputting of a user manipulation to agree with the end of the dialogue session.

7. The terminal device of claim 1, wherein the processor is further configured to control the display to display a user interface (UI) screen for editing previously defined keywords regarding a specific dialogue session in response to inputting of a user manipulation for editing the keywords.

8. The terminal device of claim 1, wherein, when an event to input a keyword for searching the dialogue session occurs, the processor is further configured to display a list of the dialogue sessions corresponding to the inputted keyword on the display.

9. The terminal device of claim 1, wherein the processor is further configured to:
display a chatting area and an associated dialogue session area respectively on a screen of the display,
display the chatting messages sent and received through the communication interface on the chatting area, and
when an event occurs, in which one keyword among the keywords stored in the storage is displayed on the chatting area, display the dialogue session matching the displayed keyword on the associated dialogue session area.

10. The terminal device of claim 1, wherein the processor is further configured to:
display a chatting area and an associated dialogue session area respectively on a screen of the display,
display the chatting messages sent and received through the communication interface on the chatting area, and
when an event occurs, in which a keyword of the dialogue session inclusive of the chatting messages displayed on the chatting area matches the previous keyword stored on the storage, display the dialogue session matching the previous keyword on the associated dialogue session area.

11. The terminal device of claim 1, wherein, in response to inputting of a user manipulation to select the dialogue session, the processor is further configured to display a new chatting screen inclusive of the chatting messages within the selected dialogue session on the display.

12. The terminal device of claim 1, wherein the processor is further configured to control the display to display background images associated with the keyword for defining the specific dialogue session on the chatting screen while the chatting messages within a specific dialogue session are displayed on the chatting screen.

13. The terminal device of claim 1, wherein the processor is further configured to determine keywords of each dialogue session based on at least one of a dialogue participant, a dialogue subject, a dialogue intention and a dialogue time regarding each dialogue session.

14. The terminal device of claim 1, further comprising:
a sensor configured to sense at least one state regarding a location of the terminal device, a movement of the terminal device, an ambient temperature of the terminal device and an ambient humidity of the terminal device,
wherein the processor is further configured to determine the keyword for defining the dialogue session which includes the inputted chatting message based on information sensed through the sensor at the moment when the chatting message is inputted.

15. The terminal device of claim 1, wherein the processor is further configured to:
receive keywords stored in another terminal device through the communication interface, and
determine a popular keyword based on the received keyword and the keywords stored on the storage.

16. The terminal device of claim 15, wherein the processor is further configured to display an automatically-suggested word on the display while the text is inputted, and the displayed automatically-suggested word is selected from the popular keywords.

17. A method of processing data in a terminal device, the method comprising:
classifying previously stored chatting messages into a plurality of dialogue sessions;
storing keywords for defining the respective classified dialogue sessions on a storage of the terminal device; and
providing a dialogue session matching at least one keyword through a display of the terminal device when an event associated with at least one keyword among the plurality of keywords stored on the storage occurs.

18. The method of claim 17, wherein the classifying comprises checking a time point when the respective chatting messages are sent or received, and classifying the chatting messages sent and received for a duration exceeding a certain time interval into different dialogue sessions to each other.

19. The method of claim 17, wherein the classifying comprises classifying the chatting messages including a specific word into the different dialogue sessions to each other based on a transmission time or a reception time.

20. A non-transitory computer readable recording medium including a program to perform a data processing method, the method comprising:
classifying previously stored chatting messages into a plurality of dialogue sessions;
storing keywords for defining the respective classified dialogue sessions on a storage of the terminal device; and
providing a dialogue session matching at least one keyword through a display of the terminal device when an event associated with at least one keyword among the plurality of keywords stored on the storage occurs.
